(19) United States
(12) Patent Application Publication
(10) Pub. No.: US 2009/0164355 A1
(43) Pub. Date: Jun. 25, 2009

(54) ACCOUNTING SYSTEM, ACCOUNTING CLIENT AND METHOD FOR REPORTING ACCOUNTING INFORMATION OF A USER BY AN ACCOUNTING CLIENT

(75) Inventors: Junxian MO, Shenzhen (CN); Jiaxing XIAO, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/392,612

(22) Filed: Feb. 25, 2009

Related U.S. Application Data
(63) Continuation of application No. PCT/CN2007/070521, filed on Aug. 20, 2007.

(30) Foreign Application Priority Data
Aug. 26, 2006 (CN) 200610115140.9

(51) Int. Cl. G06Q 10/00

(52) U.S. Cl. 705/30

(57) ABSTRACT

A method for reporting accounting information of a user by an accounting client is provided. The method includes the following steps. The accounting client correlates the accounting information of all service streams established by the user, generates an accounting packet based on a user granularity, and reports the accounting packet to an accounting server. An accounting system and an accounting client are further provided, where the accounting client correlates the accounting information of all service streams established by the user, generates the accounting packet based on the user granularity, and reports the accounting packet to the accounting server, so that an access network supporting accounting based on a service stream may report the accounting information based on the user granularity to a core network. Therefore, if the access network uses an accounting mode based on the service stream, the access network may also support a user-based accounting mode.

### CROSS-REFERENCE TO RELATED APPLICATIONS

This application is a continuation of International Patent Application No. PCT/CN2007/070521, filed Aug. 20, 2007, which claims priority to Chinese Patent Application No. 200610115140.9, filed Aug. 26, 2006, both of which are hereby incorporated by reference in their entirety.

### FIELD OF THE INVENTION

The present invention relates to the field of accounting, and more particularly to an accounting system, an accounting client, and a method for reporting accounting information by the accounting client.

### BACKGROUND

When a user uses a network, there is a need to perform an accounting operation based on the activities of the user. As shown in FIG. 1, a system for performing accounting for the user activities mainly includes a user terminal (i.e., mobile station), an accounting client, and an accounting server. If a user logs into, visits, and logs out of the network through an access network that does not support the accounting functionalities based on the service stream, the accounting client transmits accounting packets to the accounting server including an accounting start request, an interim accounting request, and an accounting stop request. The accounting server receives the accounting packets, acquires the accounting information of the user, responds to the accounting client with an accounting response packet, and generates a bill for the user according to the accounting information of the user in the received accounting packets.

In the current IP access network, in order to distinguish the service streams of different Qualities of Service (QoSs), the access network usually adopts the accounting based on the service stream instead of that based on the user connection. That is to say, after the user logs into the network successfully, instead of initiating the accounting packets such as the accounting start request instantly, the accounting client initiates an accounting process for a service stream to the accounting server after the service stream is established.

As IP networks develop, more and more broadband IP access networks start to provide services with QoS guarantee, and accordingly start to support the accounting mode based on the service stream. Due to the inaccuracy of the prior user-based accounting mode, it gradually becomes inadequate for the IP network with a Qos mechanism. In current development of the network, the access network and the core network are separately developed, and may belong to different operators. The access network may select an accounting mode different from that of the core network. If the access network selects the accounting mode based on the service stream, while the core network selects the user-based accounting mode, the access network supporting the accounting based on the service stream is not able to report the accounting information to the core network based on a user granularity, and therefore the access network and the core network cannot be interconnected to for accounting purposes.

### SUMMARY

One embodiment of the present invention provides a method for reporting accounting information of a user by an accounting client, including.

The accounting client correlates accounting information of all service streams established by the user, generates an accounting packet based on a user granularity, and reports the accounting packet to an accounting server.

An embodiment of the present invention further provides an accounting system, including an accounting client and an accounting server. The accounting client is adapted to correlate accounting information of all service streams established by a same user, generate an accounting packet based on a user granularity, and report the accounting packet to the accounting server. The accounting server is adapted to receive the accounting packet from the accounting client, and acquire the accounting information of the same user.

An embodiment of the present invention further provides an accounting client, including an accounting packet generating module and a transmitting module. The accounting packet generating module is adapted to correlate accounting information of all service streams established by a same user, generate an accounting packet based on a user granularity, and transmit the generated accounting packet to the transmitting module. The transmitting module is adapted to transmit the accounting packet from the accounting packet generating module to an accounting server.

It is known from the above solutions that, in the embodiments of the present invention, the accounting client correlates the accounting information of all service streams established by the same user, generates the accounting packet based on the user granularity, and reports the accounting packet to the accounting server, so that an access network supporting accounting based on a service stream may report the accounting information based on a user granularity to a core network. Therefore, if the access network uses an accounting mode based on the service stream, the access network may also support a user-based accounting mode.

Moreover, in the present invention, the accounting client reports the accounting packet based on the user granularity to the accounting server, so that even if the access network selects the accounting mode based on a service stream while the core network selects the user-based accounting mode, the access network and the core network may still be interconnected to perform accounting for the user.

### BRIEF DESCRIPTION OF THE DRAWINGS

FIG. 1 is a frame diagram of an accounting system;

FIG. 2 is a flow chart of reporting accounting information of a user to an accounting server by an accounting client according to an embodiment of the present invention;

FIG. 3 is a schematic view of a structure of a system according to an embodiment of the present invention;

FIG. 4 is a schematic view of a structure of an accounting client according to an embodiment of the present invention; and

FIG. 5 is a schematic view of another structure of the accounting client according to an embodiment of the present invention.

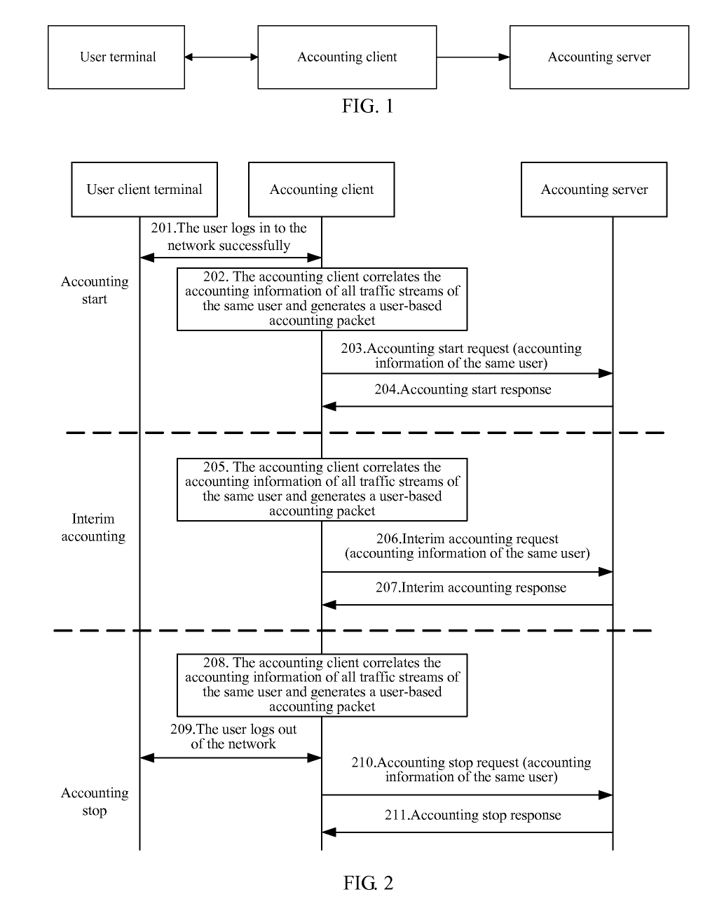

### DETAILED DESCRIPTION

The present invention is described in greater details below with reference to the accompanying figures.

An embodiment of the present invention provides a method for reporting accounting information of a user by an accounting client, including the followings. The accounting client correlates accounting information of all service streams established by the user, generates an accounting packet based on a user granularity, and reports the accounting packet to the accounting server. In the above method, the user granularity may be an IP session granularity.

The accounting client correlates a user data record of each service stream established by the same user according to a user identity (ID), acquires the accounting information of all service streams established by the user, and generates the accounting packet based on the user granularity. Here, the user ID may be an IP address of the user, that is, an Internet Protocol version 4 (IPv4) address or an Internet Protocol version 6 (IPv6) address.

The accounting client is an access server, an access gateway (ASN-GW) of a Worldwide Interoperability for a Microwave Access (WiMAX) network, a base station (BS) of the WiMAX network, a home agent (HA), a broadband access server (BAS), or a remote access server (RAS). The RAS may be a local area network (LAN) switch, an access point (AP) in a wireless local area network (WLAN), a cable modem terminal system (CMTS), or the like.

In the present invention, after a service stream is established, the accounting client is triggered to generate a user data record of the service stream. After the user logs into and logs out of the network, the accounting client correlates the user data record of all service streams established by the user according to the user ID, acquires accounting information of all service streams established by the user, generates an accounting packet based on the user granularity, and reports the accounting packet to the accounting server. In the accounting session, if an interim accounting request needs to be initiated, the accounting client may also correlate the user data record of all the established service streams according to the user ID, acquire the accounting information of all service streams established by the user, generate the accounting packet based on the user granularity, and reports the accounting packet to the accounting server.

The accounting server is usually an authentication, authorization, and accounting (AAA) server. The AAA server may specifically adopt a Remote Authentication Dial in User Service (RADIUS) protocol, a DIAMETER protocol, or a Terminal Access Controller Access Control System (TACACS) protocol. The accounting server receives the accounting packet based on the user granularity reported by the accounting client, stores the accounting information of the accounting packet, and performs accounting for the user in a user-based accounting mode.

In an embodiment of the present invention, the accounting client may correlate the accounting information of all service streams established after the user logs into the network, and records the correlated accounting information based on the user granularity in a temporary user data record (UDR), or directly sets the content of correlated accounting information based on a user granularity in the accounting packet.

In this embodiment, after the accounting client correlates the accounting information based on the user granularity of all service streams established by the same user, the correlated accounting information does not need to include the information about a single service stream. Therefore, the format of the generated temporary UDR or the content of the accounting information after the correlation statistics is different from that of the prior accounting information set in the accounting packet. The format of the generated temporary UDR based on the user granularity or the content of the accounting information based on the user granularity after the correlation is for example applied in the WiMAX network. The UDR includes the status and type, record correlators, user information, access network information, time, layer 3 (L3) statistical information, and over-the-air (OTA) statistical information, in which the access network information, the L3 statistical information, and the OTA statistical information are optional. Table 1 lists the details as follows.

TABLE 1

| | |
|---|---|
| Status and Type | The attributes in this section define the type of accounting |
| | record, convey the state of the user and describe why the |
| | record is generated. |
| Record Correlators | The attribute in this section help in correlating the records |
| | such as Start, Stop, Interim, or to a session. |
| User Identification | The attributes in this section identify the user. |
| Infrastructure Identifiers | The attributes in this section identify the serving network. |
| Time | The attributes in this section identity the time the accounting |
| | took place. The Timezone is also conveyed. |
| L3 Counters | The attributes in this section report the various L3 counters. |
| OTA Counters | The attributes in this section report the various over-the-air |
| | counters. |

Compared with the content of the accounting information in the prior accounting packet, Table 1 omits a stream description section adapted to describe characteristics of a stream and a QoS parameter section adapted to describe QoS attributes of the stream.

The following tables show the detailed contents in each section. The numbers in the last three columns of the tables indicate whether the described content exists in the accounting packet such as an accounting start request, an interim accounting request, and an accounting stop request, in which the number 1 indicates yes, 0 indicates no, and 0-1 indicates possible.

Table 2 lists the content included in the Status and Type section.

TABLE 2

| Name | Type | Descriptions | Start | Interim | Stop |
|---|---|---|---|---|---|
| Acct-Status-Type | 40 | Indicates the record type: Start, | 1 | 1 | 1 |
| | | Stop, Interim | | | |
| Acct-Terminate-Cause | 49 | Indicates why the session stopped. | 0 | 0 | 0-1 |
| Session-Continue | 26/21 | True indicates that the stop is | 0 | 0 | 0-1 |
| | | immediately followed by a start. | | | |
| | | If the attribute is missing or | | | |
| | | FALSE it means that this is the | | | |
| | | final stop. | | | |
| Beginning of | 26/22 | True: a new flow is starting. False | 0-1 | 0 | 0 |
| Session | | or missing, this is a continuation | | | |
| | | of a previous flow. | | | |
| IP technology | 26/23 | Indicates Proxy CMIPv4 mode or | 0-1 | 0-1 | 0-1 |
| | | CMIPv4 mode | | | |
| Hotline Indicator | 26/24 | Indicates that the flow is hotlined | 0-1 | 0-1 | 0-1 |
| Prepaid Indicator | 26/25 | Indicates that the user/flow is | 0-1 | 0-1 | 0-1 |
| | | being prepaid | | | |
| Class | 25 | Shall be inserted by the | 0-1 | 0-1 | 0-1 |
| | | accounting client if received in | | | |
| | | Access-Accept. | | | |

Table 3 lists the content included in the Record Correlators section.

TABLE 3

| Name | Type | Descriptions | Start | Interim | Stop |
|---|---|---|---|---|---|
| Acct-Session-Id | 44 | Used to match Starts, Stop, and | 1 | 1 | 1 |
| | | Interim. It is generated by the | | | |
| | | accounting client and is unique per | | | |
| | | start/stop pair. | | | |
| Acct-Multi-Session- | 50 | This identifier is set to the value of | 1 | 1 | 1 |
| Id | | Session-Id which is generated by | | | |
| | | AAA after successful | | | |
| | | authentication and delivered to the | | | |
| | | NAS in an Access-Accept message. | | | |
| | | It is unique per CSN and is adapted | | | |
| | | to match all accounting records | | | |
| | | within a session. | | | |
| Framed-IP-Address | 8 | The IPv4 address assigned to the | 0-1 | 0-1 | 0-1 |
| | | MS. This identifies the IP-Session | | | |
| | | (Only one of the | | | |
| | | Framed-IP-Address and the | | | |
| | | Framed-IPv6-Prefix may exist at | | | |
| | | the same time) | | | |
| Framed-IPv6-Prefix | 97 | The IPv6 prefix assigned to the | 0-1 | 0-1 | 0-1 |
| | | MS. This identifies the IP Session. | | | |
| | | (Only one of the | | | |
| | | Framed-IP-Address and the | | | |
| | | Framed-IPv6-Prefix may exist at | | | |
| | | the same time) | | | |

Table 4 lists the content included in the User Information (User Identification) section.

TABLE 4

| Name | Type | Descriptions | Start | Interim | Stop |
|---|---|---|---|---|---|
| User- | 1 | The identity and realm of the user | 1 | 1 | 1 |
| Name | | used in the outer NAI during | | | |
| | | network access authentication and | | | |
| | | authorization. | | | |
| CUI | 89 | Chargeable User Identity. It is a | 0-1 | 0-1 | 0-1 |
| | | unique temporary handle to the | | | |
| | | user responsible for paying the bill. | | | |
| | | User accounts identifier | | | |

Table 5 lists the content included in the Access Network Information (Infrastructure Identifiers) section.

TABLE 5

| Name | Type | Descriptions | Start | Interim | Stop |
|---|---|---|---|---|---|
| NAS-ID | 32 | The identifiers of the NAS | 0-1[1] | 0-1[1] | 0-1[1] |
| | | generating this record. | | | |
| Home Agent-IP | 26/ | The IP address of the home agent | 1 | 1 | 1 |
| | | (IPv4 or IPv6) | | | |
| NAS-IP-Address | 4 | The IP address of the serving NAS. | 0-1[1] | 0-1[1] | 0-1[1] |

Table 6 lists the content included in the Time section.

TABLE 6

| Name | Type | Descriptions | Start | Interim | Stop |
|---|---|---|---|---|---|
| Acct-Session-Time | 46 | The number of seconds the flow was | 0 | 0-1 | 0-1 |
| | | active. | | | |
| GMT-Time-Zone- | 26/3 | The offset in seconds from GMT at | 0-1 | 0-1 | 0-1 |
| Offset) | | the NAS or HA. | | | |
| Event-Timestamp | 55 | The time the event occurred. | 1 | 1 | 1 |
| Active time | 26/ | The time in which the MS is active | 0 | 1 | 1 |
| | | as opposed to idle mode. | | | |

Table 7 lists the content included in the L3 Counters, which shows the statistical information generated after the accounting client correlates the corresponding information in the UDR of each service stream established after the same user logs in to the network.

TABLE 7

| Name | Type | Descriptions | Start | Interim | Stop |
|---|---|---|---|---|---|
| Acct-Input-Octets | 42 | Uplink byte traffic | 0 | 0-1 | 0-1 |
| Acct-Output-Octets | 43 | Downlink byte traffic | 0 | 0-1 | 0-1 |
| Acct-Input-Packets | 47 | Uplink packet traffic | 0 | 0-1 | 0-1 |
| Acct-Output-Packets | 48 | Downlink packet traffic | 0 | 0-1 | 0-1 |
| Acct-Input-Gigawords | 52 | Incremented when attribute 42 | 0 | 0-1 | 0-1 |
| | | overflows | | | |
| | | Uplink byte traffic high level | | | |
| Acct-Output-Giga | 53 | Incremented when attribute 43 | 0 | 0-1 | 0-1 |
| words | | overflows | | | |
| | | Downlink byte traffic high level | | | |
| Control Packets In | 26/ | Uplink signaling packet traffic | 0 | 0-1 | 0-1 |
| Control Octets In | 26/ | Uplink signaling byte control traffic | 0 | 0-1 | 0-1 |
| Control Packets | 26/ | Downlink signaling packet traffic | 0 | 0-1 | 0-1 |
| Out | | | | | |
| Control Octets Out | 26/ | Downlink signaling byte control | 0 | 0-1 | 0-1 |
| | | traffic | | | |

The above tables respectively show the content derived from performing the correlation and summarization on the UDR of each service stream by the accounting client. The accounting client establishes an accounting session of a user level according to the content, generates an accounting packet based on the user granularity, and reports the generated accounting packet based on the user granularity to an accounting server of a core network supporting user-based accounting.

In this embodiment, the process for reporting the accounting information to the accounting server by the accounting client is shown in FIG. 2, and specifically includes the following steps.

Step 201: After a user logs into a network through a user client terminal successfully, one or more service streams are established on the network for the user, and a UDR is generated in the accounting client for each established service stream. After the user logs into the network successfully, the accounting client detects the information about the completion of the service stream establishment for service streams established in the service operation, and generates a UDR for each established service stream.

Step 202: After the user logs into the network successfully, the accounting client correlates the accounting information in the UDR of all service streams of the same user according to the user ID in the UDR, constructs accounting information based on a user granularity according to the correlated content, and generates a user-based accounting packet, that is, generates an accounting start request. The accounting start request carries the accounting information based on the user granularity. In Step 202, the user ID is the information in the accounting client for uniquely identifying a user, such as an IPv4 address, an IPv6 address, or an IPv6 prefix.

In this embodiment, the content in the accounting information set by the accounting client in accounting packets including the accounting start request, and the subsequent interim accounting request and accounting stop request in Step 202 is shown above in Tables 1-7.

Step 203: The accounting client reports the accounting start request to the accounting server.

Step 204: The accounting server receives the accounting start request, records the information such as the user, accounting session, start time of the user address, and current traffic in the packet, and make a response to the accounting client to indicate that the accounting client may start an accounting.

Step 205: According to the network condition and operation requirements, if a real-time protection on the accounting information is required, an interim accounting packet may be provided during the accounting. Meanwhile, according to a predetermined interim period, the accounting client correlates the accounting information in the UDR of all service streams of the user according to the user ID in the UDR, constructs accounting information based on the user granularity according to the correlated content, and generates a user-based accounting packet, that is, generates an interim accounting request. The interim accounting request carries the accounting information based on the user granularity.

Step 206: The accounting client reports the interim accounting request generated in Step 205 to the accounting server.

Step 207: The accounting server receives the interim accounting request, records the information such as a time of using the network or used network traffic, and responds to the accounting client with an interim accounting response to indicate that the accounting client may continue the interim accounting.

Step 208: After the user logs out of the network through a user access terminal, all service streams are terminated.

Step 209: After sensing the logout of the user from the network, the accounting client correlates the accounting information in the UDR of all service streams of the same user according to the user ID in the UDR, constructs accounting information based on the user granularity according to the correlated content, and generates a user-based accounting packet, that is, generates an accounting stop request. The accounting stop request carries the accounting information based on the user granularity.

Step 210: The accounting client reports the accounting stop request generated in Step 209 to the accounting server.

Step 211: The accounting server receives the accounting stop request, and responds to the accounting client with an accounting stop response to indicate that the accounting client may terminate the accounting. In the above method, the user granularity may be an IP session granularity.

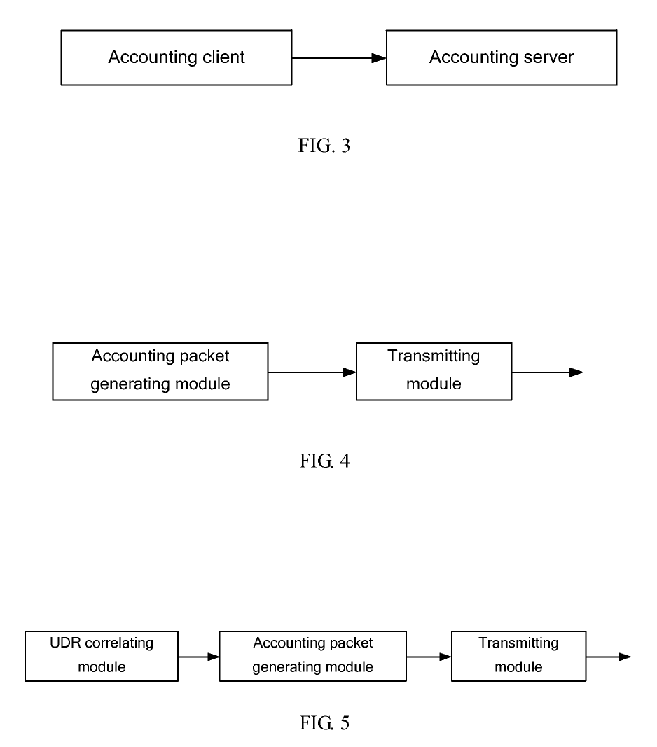

The accounting system disclosed in the present invention is shown in FIG. 3, including an accounting client and an accounting server. The interactions between the accounting client and the accounting server and the respective processes have been described in the above embodiment, and a brief description is further given as follows.

The accounting client is adapted to correlate accounting information of all service streams established by a same user, generate an accounting packet based on a user granularity, and report the accounting packet to the accounting server. The accounting server is adapted to receive the accounting packet from the accounting client, and acquires the accounting information of the same user.

As shown in FIG. 4, the accounting client may specifically include an accounting packet generating module and a transmitting module. The accounting packet generating module is adapted to correlate accounting information of all service streams established by a same user, generate an accounting packet based on a user granularity, and transmit the accounting packet to the transmitting module. The transmitting module is adapted to transmit the accounting packet from the accounting packet generating module to the accounting server.

Moreover, the accounting client further includes a UDR correlating module. As shown in FIG. 5, the UDR correlating module is adapted to correlate accounting information in a user data record of each service stream according to a user ID, and provide the correlated accounting information to the accounting packet generating module. The accounting packet generating module generates the accounting packet based on the user granularity according to the accounting information from the UDR correlating module.

An embodiment of the present invention further provides an accounting server, which may include an accounting packet receiving module and an accounting information acquiring module. The accounting packet receiving module is adapted to receive an accounting packet based on a user granularity generated by correlating accounting information of all service streams established by the same user. The accounting information acquiring module is adapted to acquire the accounting information of the same user according to the accounting packet.

In actual applications, whether to perform the interim accounting or not, whether or not the accounting server performs accounting for the user according to the accounting information reported by the accounting client through the accounting packets such as the accounting start request, the interim accounting request, and the accounting stop request, the accounting policies such as time-based accounting, accounting based on the service stream, and accounting based on the network position can all be configured according to the network condition and the operation requirements of the user.

The present invention is applicable to various IP access networks supporting the accounting based on the service stream, which include but are not limited to the WiMAX network. When the present invention is applied in the WiMAX network, the accounting based on the user granularity in the present invention is corresponding to the IP session based accounting in the WiMAX standard.

Though illustration and description of the present disclosure have been given with reference to the embodiments thereof, it should be appreciated by persons of ordinary skill in the art that various changes in forms and details can be made without deviation from the spirit and scope of this disclosure, which are defined by the appended claims.

What is claimed is:

1. A method for reporting accounting information of a user by an accounting client comprising:
correlating, by the accounting client, the accounting information of all service streams established by the user;
generating an accounting packet based on a user granularity; and
reporting the accounting packet to an accounting server.

2. The method according to claim 1, wherein the user granularity comprises an IP session granularity.

3. The method according to claim 1, wherein the correlating, by the accounting client, the accounting information of all service streams established by the user and the generating the accounting packet based on the user granularity comprises:
correlating, by the accounting client, a user data record of each of the service streams established by the user according to a user identity (ID), acquiring the accounting information of all of the service streams established by the user, and generating the accounting packet based on the user granularity.

4. The method according to claim 3, wherein the user ID comprises an IP address of the user.

5. The method according to claim 4, wherein the IP address comprises one of an Internet Protocol version 4 (IPv4) address and an Internet Protocol version 6 (IPv6) address.

6. The method according to claim 1, wherein the accounting packet comprises a user data record, and the user data record comprises at least:
a status, a type, record correlators, user information, and time.

7. The method according to claim 2, wherein the accounting packet comprises a user data record, and the user data record comprises at least:
a status, a type, record correlators, user information, and time.

8. The method according to claim 6, wherein the user data record in the accounting packet further comprises
one or more of access network information, layer 3 (L3) statistical information, and over-the-air (OTA) statistical information.

9. The method according to claim 6, wherein the record correlators comprise an accounting session identifier and an accounting multi-session identifier.

10. The method according to claim 1, wherein the accounting packet comprises an accounting start request and an accounting stop request.

11. The method according to claim 1, wherein the accounting packet comprises an interim accounting request.

12. An accounting client comprising an accounting packet generating module and a transmitting module wherein:
the accounting packet generating module is adapted to correlate accounting information of all service streams established by a user, generate an accounting packet based on a user granularity, and transmit the generated accounting packet to the transmitting module; and
the transmitting module is adapted to transmit the accounting packet from the accounting packet generating module to an accounting server.

13. The accounting client according to claim 12, further comprising a user data record (UDR) correlating module, wherein the UDR correlating module is adapted to correlate the accounting information in a user data record of each of the service streams established by the user according to a user identity, and provide the correlated accounting information to the accounting packet generating module; and
the accounting packet generating module is adapted to generate the accounting packet based on the user granularity according to the accounting information from the UDR correlating module.

14. An accounting server comprising an accounting packet receiving module and an accounting information acquiring module wherein:
the accounting packet receiving module is adapted to receive an accounting packet based on a user granularity generated by correlating accounting information of all service streams established by a user; and
the accounting information acquiring module is adapted to acquire the accounting information of the user according to the accounting packet.
